(19) United States
(12) Patent Application Publication
(10) Pub. No.: US 2017/0076323 A1
(43) Pub. Date: Mar. 16, 2017

(54) MATCHING DEVICES WITH ENTITIES USING REAL-TIME DATA AND BATCH-PROCESSED DATA

(71) Applicant: Adobe Systems Incorporated, San Jose, CA (US)

(72) Inventors: Virgil-Artimon Palanciuc, Bucharest (RO); Mihai Daniel Fecioru, Bucharest (RO); Charles Menguy, New York, NY (US); David Weinstein, Rockville Centre, NY (US)

(21) Appl. No.: 14/851,316

(22) Filed: Sep. 11, 2015

(51) Int. Cl. G06Q 30/02

(52) U.S. Cl. CPC G06Q 30/0255; G06Q 30/0277

(57) ABSTRACT

Certain embodiments involve matching devices that access online services with users or households using a combination of real-time data and batch-processed data about the devices. For example, a data management system generates a device cluster that identifies devices associated with a user or household. The device cluster is generated by batch-processing data received from devices accessing the online services and data received from third parties that describes devices that have accessed other online services. The data management system subsequently identifies a device that is accessing a first online service. The data management system matches the identified device to the device cluster based on a combination of the batch-processed data and data about the identified device received in real-time from a second online service. The identified device is matched to the device cluster while the identified device is accessing the online service.

### TECHNICAL FIELD

This disclosure relates generally to computer-implemented methods and systems and more particularly relates to matching devices with entities using real-time data and batch-processed data.

### BACKGROUND

Digital marketers and other providers of online services provide features that are at least partially customized to certain users, households, or other logical entities. For example, it may be desirable for an online retail website to tailor the layout of the website, the product recommendations, or some other aspect of the website to a given user's preferences. To address this need, the systems that are used to customize a website experience attempt to identify specific visitors (e.g., users or households) that have previously visited the website rather than simply the devices that have accessed the website. For instance, if the same user accesses the website from an office computer and later accesses the website from a home computer, the website experience should be customized in the same manner even though two different devices on two different networks were used to access the website. Moreover, a website visit or other online experience can be better tailored for the visitor if the website provider accounts for information about the visitor from interactions on both devices.

Therefore, identifying a visitor, rather than just a device, is important in digital marketing or any other online service that involves customizing an online experience. Certain data management systems support multiple online services by using data from one online service to assist another online service in customizing an online experience. In a simplified example, a data management system with access to large amounts of data from multiple online services executes a batch-processing algorithm for identifying sets of devices (i.e., “clusters”) that are likely to belong to the same user or other entity. If one of the online services encounters a given device for the first time, the data management system uses a device cluster generated from data provided by other online services to identify the likely user of the device. The data management system notifies the online service of the likely user of the newly encountered device, which allows the online service to customize a website experience to the user even without the user logging into that service.

A prior solution for generating these clusters involves batch-processing data received from different sources to generate clusters for matching devices to users. In this solution, large amounts of data describing device usage are retrieved or otherwise accessed. For instance, on a daily or weekly basis, a system executes a clustering algorithm using historical data about devices that accessed one or more online services over a period of twelve months. The clustering algorithm generates or updates clusters of data points that indicate, for example, which device was used by which user at different points in time. These clusters of data points allow the system to determine a likelihood that a given device used to access a website or other online service is associated with a given user.

A reliance on this type of batch-processing presents disadvantages. For example, reliance on batch-processing may generate inaccurate matches between users and devices if a user has recently changed his or her device (e.g., because the device itself has been sold to another user, because the user has purchased a new device, etc.). These inaccurate matches result from changes in device ownership that occur between scheduled batch-processing tasks. Furthermore, reliance on batch-processing alone may cause the online service to disregard newly encountered devices when customizing a website or other online experience. For example, even if a user frequently accesses a website, the user may not be matched to a particular device if the user has not accessed the website from that specific device. Therefore, the online service may fail to customize the website to the user's preferences.

Another prior solution involves executing a clustering algorithm each time a user accesses an online service or each time a new device is used to access the online service. However, this solution is infeasible in systems where a quick response time is a high priority. For example, customizing an online experience to a particular user requires response times on the order of hundreds of milliseconds. By contrast, an extensive amount of time may be required to execute a clustering algorithm over an entire set of device data (i.e., the historical device data and the newly encountered device data). Therefore, improving the accuracy of a user-to-device match for customizing the website may sacrifice the responsiveness of the website, which decreases the quality of service of the online experience.

Therefore, it is desirable to provide accurate, highly responsive matching between devices that are currently accessing an online service and users, households, or other entities that have historically accessed the online service.

### SUMMARY

According to certain embodiments, systems and methods are provided for matching devices with entities using real-time data and batch-processed data. In one example, a data management system generates a device cluster that identifies devices associated with a user or household. The device cluster is generated by batch-processing a first set of data that describes devices accessing the online services and a second set of data that describes devices that have accessed other online services. The data management system subsequently identifies a device that is accessing one of the online services. The data management system matches the identified device to the previously generated device cluster based on a combination of the batch-processed data and data about the identified device that is received in real-time from another one of the online services. The identified device is matched to the device cluster while the identified device is accessing the online service. In some cases, matching the device cluster to the identified device allows an online experience provided by the online service to be customized to a user or household described by the device cluster.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

Features, embodiments, and advantages of the present disclosure are better understood when the following Detailed Description is read with reference to the accompanying drawings, where:

FIG. 1 is a block diagram depicting a computing environment in which a data management system matches computing devices with users, households, or other entities using real-time data and batch-processed data according to certain exemplary embodiments;

FIG. 2 is a block diagram depicting an online service receiving real-time data that may be used by the data management system of FIG. 1 to match a computing device with users, households, or other entities according to certain exemplary embodiments;

FIG. 3 is a block diagram depicting the online service of FIG. 2 providing the real-time data to the data management system for matching the computing device with users, households, or other entities according to certain exemplary embodiments;

FIG. 4 is a block diagram depicting the data management system augmenting device cluster data from a batch-processing algorithm after the receipt of device data depicted in FIG. 3 according to certain exemplary embodiments;

FIG. 5 is a block diagram depicting an additional online service receiving real-time data about the computing device after the data management system has performed the updates depicted in FIG. 4 according to certain exemplary embodiments;

FIG. 6 is a block diagram depicting the online service of FIG. 5 querying the data management system about users, households, or other entities that may match the computing device according to certain exemplary embodiments;

FIG. 7 is a block diagram depicting the data management system using the augmented device cluster data to find a potential device user that matches the query depicted in FIG. 6 according to certain exemplary embodiments;

FIG. 8 is a block diagram depicting the data management system responding to the query with the potential user identified in FIG. 7 according to certain exemplary embodiments;

FIG. 9 is a block diagram depicting the online service using the uidentified user depicted in FIG. 8 to customize an online experience for the computing device according to certain exemplary embodiments;

FIG. 10 is a flow chart depicting an example of a process for matching a device that accesses an online service with a specific user or household using a combination of real-time data and batch processed data about the device received from multiple online services according to certain exemplary embodiments;

FIG. 11 is a flow chart depicting an example of a process for generating a new device cluster based on a failure to match a device with a specific user or household according to certain exemplary embodiments;

FIG. 12 is a flow chart depicting an example of a process for resolving conflicts between real-time device data and batch-processed device data in matching a device to a user or household according to certain exemplary embodiments; and

FIG. 13 is a block diagram depicting an example of a data management system that matches computing devices with users, households, or other entities using real-time data and batch-processed data according to certain exemplary embodiments.

### DETAILED DESCRIPTION

As discussed above, prior techniques for matching devices with users and other entities may provide inaccurate results due to their failure to leverage real-time data. Embodiments are disclosed that allow a data management system to use a combination of batch-processed data and real-time data to accurately and quickly match devices (e.g., smart phones, laptops, etc.) with individuals, households, or other entities that access different online services supported by the data management system. The data management system supports the online services by, for example, notifying a certain online service that a device accessing the online service likely belongs to a certain user or household, which allows the online service to customize an online experience for that user even if the user has not logged into the service. For example, the data management system can access a device-to-user association (i.e., a device cluster) that has been generated using large, batch-processed sets of data describing devices that have accessed different online services combined with real-time data about devices that has been obtained since the most recent batch-processing of data. In this manner, the data management system leverages both the large data sets obtained over long periods of time and more recent data obtained through real-time interactions with online services to quickly and accurately match devices with users, households, and other entities.

In some embodiments, a data management system is used by multiple, independent online services (e.g., a social media service, an online merchant, etc.) for processing data collected by the online services. The data management system receives and responds to queries from the online services regarding which devices belong to a user, a household, or other entity. In one example, a social media service requests, from the data management system, a user or household that is associated with a device being used to access the online service. The data management system matches the device to a user or household and provides the matching data to the social media service. The social media service uses the matching data to customize an online experience provided to the device based on a likely user of the device.

The data management system uses device clusters to obtain these user-to-device matches. To generate a device cluster, the system obtains device data from a wide array of data sources. These data sources include both first-party sources (e.g., data describing different devices that have accessed the current online service) and third-party sources (e.g., data describing different devices that have accessed other online services). In a simplified example, a large data set available to the data management system includes records of associations between certain device identifiers (e.g., network addresses or other device identifiers for smart phones, laptops, etc.), certain user identifiers (e.g., credentials used to access online services, etc.), and other data indicating a device-to-user match (e.g., geographic locations in which a device was used that are near the user's house). Clustering these records together allows the system to determine whether a given device is frequently associated with a user (e.g., because multiple records from different points in time show the same user-to-device combination) or infrequently associated with a user (e.g., because multiple records from different points in time show different users accessing the same device).

In some embodiments, the data management system responds to queries from online services using a combination of the device clusters and real-time data that has been received by the data management system since the device clusters were last updated. In a simple example, a social media service notifies the data management system that a certain device, which is located near certain GPS coordinates, is accessing the social media service. The data management system determines, from the existing data clusters, that a certain set of devices have historically been used to access the social media service from a household near these GPS coordinates. The data management system updates the set of devices for the household to include the device identified by the social media service. If an online shopping service subsequently requests that the data management system identify a potential user or household associated with the device, the data management system uses the updated set of devices to notify the online shopping service that the device likely belongs to a member of the identified household. In this manner, the data management system can use both the batch-processed data (e.g., the previously identified list of devices for a household) and real-time data (e.g., the data received from the social media service) to quickly and accurately identify potential users of the device to the online shopping service, thereby allowing the online shopping service to present one or more web pages that are customized for those potential users, even if none of the users have logged into the online shopping service.

In some embodiments, device data collected in real-time is provided to a subsequently scheduled batch-processing operation. In the example above, the data management system may temporarily update the list of devices for the household based on the device data received from the social media service in order to quickly respond to queries about the device that was newly encountered by the social media service. During a subsequent batch-processing operation, the data management system uses the device data received from the social media service in combination with device data obtained from other online services to generate or update device clusters. This batch-processing operation, which involves a more complex analysis of a larger data set, may verify with a higher level of confidence that the newly encountered device belongs to list of devices for the household.

In some embodiments, the use of real-time data and batch-processed data allows the data management system to take advantage of the accuracy provided by batch-processing without severely impacting the desired response times for acting on requests from online services. When trying to find a match for a given device, a faster response time will result if a smaller set of data is searched, while a more accurate match will result if a larger data set is searched. For example, if the data management system received a request to match a user with a device having a device identifier “12345,” and the data management system only searched device identifiers, a response could be obtained quickly, but may be incomplete (e.g., by omitting potential users that could be associated with the device through probabilistic methods). By contrast, if the data management system received a request to match a user with a device having a location “Street Address 1” and a browsing history “Web page 1→Web page 2→Web page 3,” the data management system could provide the most accurate response by searching every browsing history record and every location record to determine the probability that certain users are associated with the device. However, due to the size of the data set and the processing complexity of certain probability algorithms, searching sets of individual records and executing these probability algorithms on those records would require a longer response time.

Some embodiments of the data management system address these issues by using clusters of device or user data, rather individual records, to respond to queries. Searching clusters rather than individual records involves searching a smaller set of data. Matching a device to a cluster rather than individual records may also involve executing algorithms with reduced processing complexity as compared to the batch-processing algorithms described above. For instance, the data management system can create temporary associations between devices and clusters in real time based on the match, which can later be verified using large data sets and more advanced matching algorithms during a batch-processing algorithm. The temporary associations used in real time require fewer computing resources (and can therefore be performed more quickly), which allows real-time information to be used in combination with previously batch-processed information without re-running the batch-processing algorithm each time new information is encountered. Accordingly, in certain embodiments, the data management system uses a baseline of highly accurate data (e.g., clusters obtained from batch-processing) and, prior to the next batch-processing operation, performs low-complexity updates of that baseline data using real-time data.

As used herein, the term “online service” is used to refer to one or more computing resources, including computing systems that may be configured for distributed processing operations, that provide one or more applications accessible via a data network. The collection of computing resources can be represented as a single service. In some embodiments, an online service provides a digital hub for browsing, creating, sharing, and otherwise using electronic content using one or more applications provided via the online service.

As used herein, the term “matching” refers to determining an association between a device and an entity, such as a user or household. In one example, matching a user to a device includes identifying the user as a potential owner of the device, a frequent user of the device, or both. In some embodiments, matching the user involves determining the probability that an entity is associated with a device and identifying the entity as a probable user of the device based on the determined probability being above a threshold probability.

As used herein, the term “user” is used to refer to an individual, organization, or other logical identity that can be uniquely identified by an online service or other application. In various embodiments, users are identified by reference to one or more client accounts, by reference to a software identifier or hardware identifier associated with an application, by reference to a device used to access a service, or by reference to any other suitable identifier or combination of identifiers that allow an online service to distinguish between two logical entities.

As used herein, the term “household” is used to refer to two or more users that are grouped together by a data management service or other online service based on the users sharing one or more common attributes. In some embodiments, a household is a group of users in which devices are shared among different users. For example, the data management system may determine, using deterministic or probabilistic methods, that a first set of devices (e.g., device D1, device D2, and device D3) belong to a first user (e.g., user U1), that a second set of devices (e.g., devices D4 and D5) belong to a second user (e.g., user U2), and that a third set of devices (e.g., devices D6 and D7) belong to a third user (e.g., user U3). However, although devices D2 and D3 have been identified as belong to user U1, the data management system may determine that user U2 has been seen logging on devices D2 and D3, although user U2 may do so far less frequently than user U1. The data management system may also determine that the devices D5, which belongs to the user U2, and the devices D6 and D7, which belong to the user U3, have used the same IP address (e.g., an IP address assigned to a router that is used by the devices to access the Internet). Based on a combination of the overlapping device usage and IP addresses, the data management system assigns the devices D1-D7 with a common household.

As used herein, the term “batch-processing” is used to refer to automatically executing multiple tasks on a set of data to derive one or more outputs from the set of data. In some embodiments, batch-processing is performed at scheduled interval of time (e.g., daily, weekly, monthly, etc.) on data from one or more specified data sources (e.g., a set of records meeting specified criteria that are stored in a specified database). Batch-processing data allows complex operations to be performed on large data sets, which may provide more accurate outputs than using simpler operations on smaller data sets. In some embodiments, the complexity of a batch-processing operation, the size of the data set used by the batch-processing operation, or both results in longer processing times as compared to simpler operations performed on real-time data.

As used herein, the term “real-time data” is used to refer to data received by a data management service or other online service at some point in time between at least two scheduled batch-processing operations. In some embodiments, the real-time data includes any data received after the most recent batch-processing operation. Thus, the real-time interval corresponds to the interval between two batch-processing operations.

As used herein, the term “device cluster” is used to refer to a set of data identifying associations between devices and users, households, or other entities. In some embodiments, a device cluster is generated by batch-processing a variety of different device data that directly or indirectly describes one or more attributes of a user, a device, or both. Examples of data used to generate a device cluster include authentication data describing users or devices that have been authenticated by online services, web browsing histories for users or devices, search histories from the devices, IP addresses of devices that have accessed online services, geographic location data for users or devices, etc.

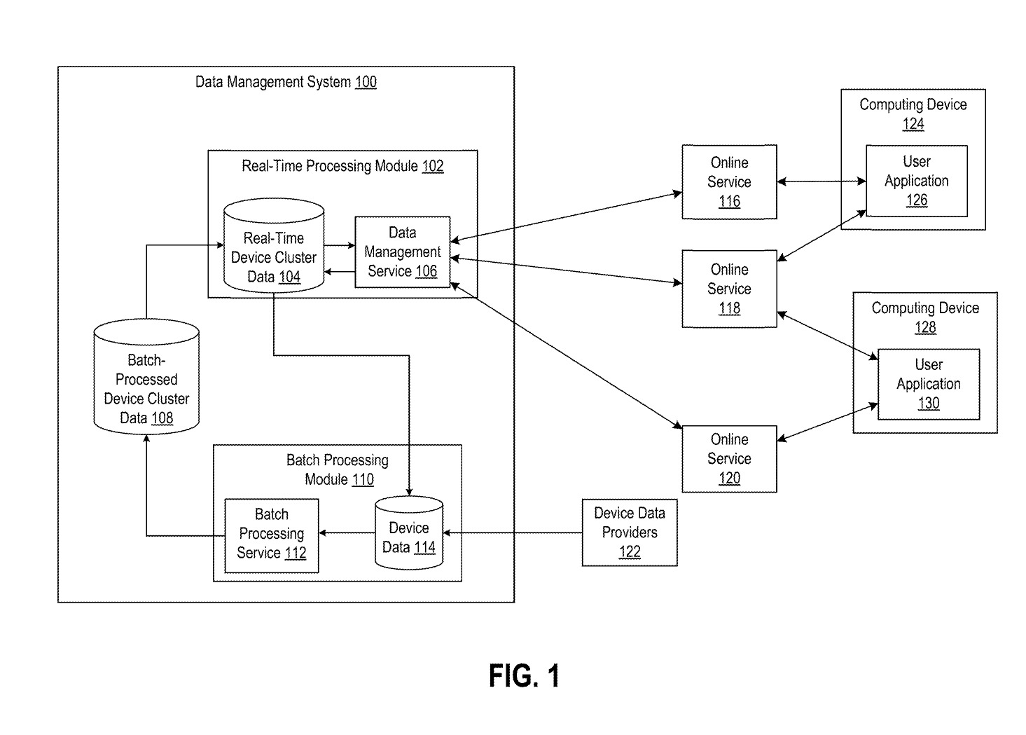

Referring now to the drawings, FIG. 1 is a block diagram depicting a computing environment in which a data management system 100 matches computing devices 124, 128 with users, households, or other entities using real-time data and batch-processed data. The data management system 100 includes one or more computing systems with one or more processing devices, which may (in some embodiments) be configured for distributed processing operations. The data management system 100 accesses relevant data about devices and users and executes suitable program code for matching devices and users.

In the example depicted in FIG. 1, the data management system 100 uses a real-time processing module 102 with real-time device cluster data 104 used by a data management service 106. The data management system 100 also uses batch-processed device cluster data 108 from which the real-time device cluster data 104 is at least partially obtained. The data management system 100 also uses a batch-processing module 110 that uses device data 114. These services and data sets are stored in suitable non-transitory computer-readable media that are included in the data management system 100, accessible to the data management system 100 via a data network, or otherwise communicatively coupled to one or more processing devices of the data management system 100.

In some embodiments, the data management system 100 executes the data management service 106 to process data and queries received from one or more online services 116, 118, 120. The online services 116, 118, 120 provide applications, data, and other functions that are accessed by one or more computing devices 124, 128 via the Internet or another suitable data network. Examples of the online services 116, 118, 120 include (but are not limited to) social media websites, websites for purchasing products or services, etc. The computing devices 124, 128 execute respective user applications 126, 130 that are used to access the online services 116, 118, 120. Examples of the user applications 126, 130 include, but are not limited to, web browsers for accessing websites provided by the online services, applications specific to the online services, etc.

In some embodiments, the data management system 100 allows user data, device data, or both that is received from different, independent online services to be processed together. For example, one or more of the online services 116, 118, 120 may operate independently of one another by belonging to different network domains, being controlled by different operators, etc. Even though the online services may be independent of one another, information about device usage by different users, user activity at different websites, and the like can be collected into one or more common data sets by the data management service 106 and used by the data management service 106 to derive data about the users, devices, etc. This common processing of the data received from the different online services allows the data management system 100 to achieve more accurate results (e.g., in matching users to devices) than each online service may be able to achieve on its own.

In some embodiments, the data management system 100 receives and responds to queries from the online services 116, 118, 120 requesting information about which devices belong to a user, a household, or other entity. In one example, the online service 116 requests an identification of a potential user or household that are associated with a computing device 124, which has established a session with the online service 116 or is otherwise accessing the online service 116. The data management system 100 uses data that has been collected from the online service 116, the online services 118 and 120, other device data providers 122, or some combination thereof to identify a likely user of the computing device 124. The data management system 100 notifies the online service 116 of the likely user of the computing device 124, which allows the online service 116 to transmit data to the computing device 124 that is customized to the likely user.

The data management system 100 uses real-time device cluster data 104 to obtain these user-to-device matches. The real-time device cluster data 104 includes a combination of device cluster data obtained from the batch-processed device cluster data 108 and data collected in real time by the data management service 106. The batch-processed device cluster data 108 includes device clusters that identify associations between devices and users, households, or other entities. The real-time data includes information about users and devices that has been received from the online services 116, 118, 120 since a previous batch-processing operation.

In the example depicted in FIG. 1, the data management system 100 uses the batch-processing module 110 to generate the batch-processed device cluster data 108. The data management system 100 executes the batch-processing service 112 to generate or update device clusters from the device data 114. The device data 114 includes a large set of data describing different attributes associated with various computing devices, users, etc.

Examples of the device data 114 include, but are not limited to, authentication data and probabilistic data. Authentication data includes any data describing user credentials that have been used to authenticate a user for access to an online service (e.g., records indicating that a certain user provided certain credentials for authentication purposes when using a particular device). Authentication data allows the data management service to associate certain user identifiers to devices, even if the users themselves remain anonymous. For example, authentication data may indicate that a user name “Anonymous_Person52” has historically been received by the online service 120 from the computing device 128 when that user has accessed the online service 120. The authentication data therefore indicates that a certain user (e.g., “Anonymous_Person52”) has used the computing device 128 at least once. Probabilistic data includes information other than authentication data that indicates associations between devices and users, households, or other entities. Examples of this probabilistic data include IP addresses of computing devices that have accessed online services, histories of web browsing performed by certain computing devices, search histories for certain computing devices, geographic location data describing device locations, geographic location data describing user locations, etc.

The data management system 100 receives the device data 114 from device data providers 122 and the real-time processing module 102. The device data providers 122 include a wide array of data sources, such as (but not limited to) first-party sources, second-party-sources, and third-party sources. First-party data includes data describing different devices that have accessed online services 116, 118, 120 serviced by the data management system 100. Second-party data includes data that describes devices or users and that has been obtained by the online services 116, 118, 120 from other entities (e.g., device data shared with a social media service by a vendor who advertises on the social media service). In various embodiments, the online services 116, 118, 120 provide first-party data and second-party data in real time (e.g., via the communications between the online services and the real-time processing module 102 indicated in FIG. 1), at scheduled intervals (e.g., via the communications between the device data providers 122 and the batch-processing module 110 indicated in FIG. 1), or both. Third-party data includes any other data describing users, devices, or both that have accessed one or more online services 116,118, 120 or one or more other online services (e.g., services that do not communicate with the data management system 100).

The data management system 100 executes the batch-processing service 112 to generate batch-processed device cluster data 108 from the device data 114. The batch-processed device cluster data 108 includes device clusters that indicate associations between devices and users, households, or other entities. The batch-processing service 112 generates device clusters from correlations between different types of data. The device clusters indicate associations between users and devices that may not be readily apparent from authentication data alone.

In a simplified example, the batch-processing service 112 uses records of probabilistic data about users and devices to generate a device cluster. A first device may be used to search for a vacation in a certain region (e.g., Bali) having a certain level of expense (e.g., for four-start hotels). Geographic data (e.g., GPS data) may be used to geo-locate the device on a certain street. During the same week, a second device may be used to search for a vacation in a certain region (e.g., Bali) having a certain level of expense (e.g., for four-star hotels). The data management system 100 uses the combination of data about the first device and the second device to determine that both devices likely belong to the same user or household.

In some embodiments, after generating or updating the batch-processed device cluster data 108 using the batch-processing service 112, the data management system 100 creates a copy of the batch-processed device cluster data 108 for use by the real-time processing module 102. This copy is the real-time device cluster data 104. During real-time operations (e.g., between scheduled batch-processing operations), the data management system 100 updates device clusters described by the real-time device cluster data 104 based on information received from the online services 116, 118, 120.

For example, the online service 116 (e.g., a social media service) may notify the data management service 106 that a newly encountered device is accessing the online service 116. The online service 116 provides information about the device, such as its geographic location, to the data management service 106. The data management service 106 identifies one or more clusters in the real-time device cluster data 104 that correspond to the geographic location (e.g., a cluster indicating associations between “Street Address 1” and “Anon_User_1” the example above). The data management service 106 associates the newly encountered device with the identified cluster (in particular, with “Anon_User_1”) in the real-time device cluster data 104. The update to the identified cluster may not use the full range of data that may be available during a batch-processing operation (e.g., third-party information associated with the newly encountered device). Using a smaller subset of data (e.g., the clustered device data) allows the association between “Anon_User_1” and the newly encountered device to be determined more quickly than would be available via batch-processing.

This association between the newly encountered device and “Anon_User_1” can later be verified (or modified) by the batch-processing service 112. Specifically, the real-time data received from the online service 116 (e.g., that the newly encountered device accessed the online service 116 from the geographic location “Street Address 1”) is an example of first-party data included in the device data 114. The batch-processing service 112 may use other information about the newly encountered device from the device data providers 122 to verify that the newly encountered device belongs to the device cluster identified in real time by the data management service 106. Additionally or alternatively, the batch-processing service 112 may use information from the device data providers 122 about the newly encountered device to assign the newly encountered device to a more appropriate device cluster.

The data management system 100 determines, from the existing data clusters, that a certain set of devices have historically been used to access the social media service from a household near these GPS coordinates. The data management system 100 updates the set of devices for the household to include the device identified by the social media service. If a shopping service subsequently requests that the data management system 100 identify a potential user of the same device, the data management system 100 uses the updated set of devices to notify the online shopping service that the device likely belongs to a member of the identified household. In this manner, the data management system 100 can use both the batch-processed data (e.g., the previously identified list of devices for a household) and real-time data (e.g., the data received from the social media service) to quickly and accurately identify a potential user of the device to the online shopping service, thereby allowing the online shopping service to present one or more web pages that are customized for those potential users, even if none of the users have logged into the online shopping service.

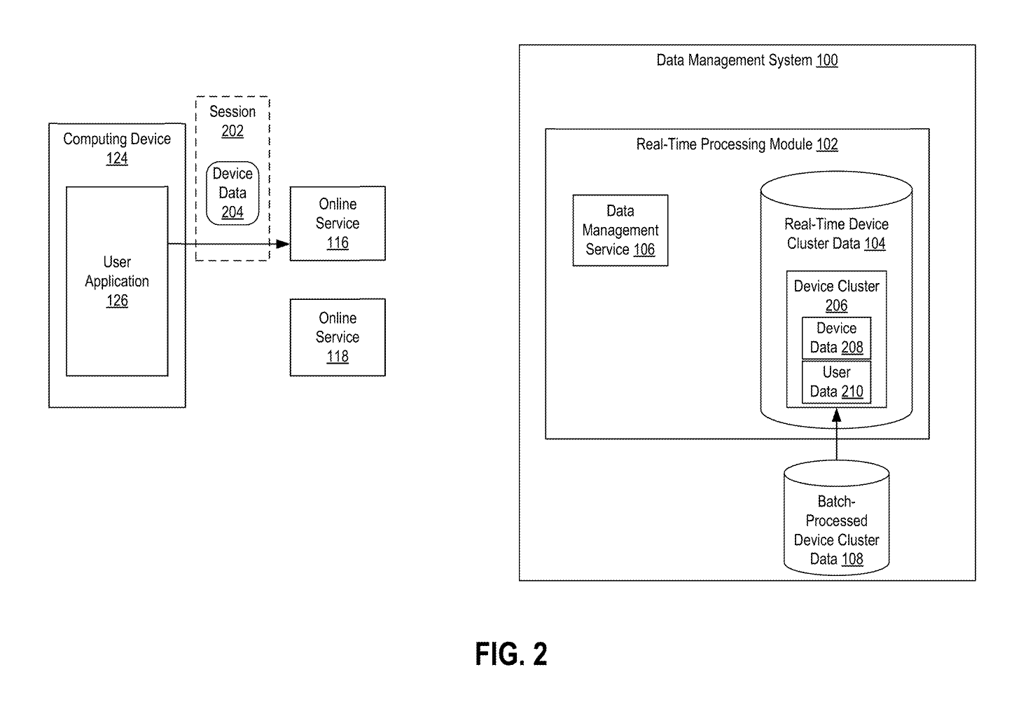

FIGS. 2-9 depict an example of the data management system 100 using a combination of batch-processed data and real-time data to match computing devices to users or households. These simplified examples are provided for illustrative purposes only. Any number of online services may provide any type of real-time data to the data management system 100 for use in matching devices to users, households, or other entities.

In the example depicted in FIG. 2, a computing device 124 establishes a session 202 with the online service 116. A session can include a period during which a computing device accesses services or applications via an online service, such as (but not limited to) the period that begins when a computing device connects to a server providing the online service and that ends when the computing device disconnects from the server

In some embodiments, establishing the session 202 involves the user application 126 logging into the online service 116 by providing authentication data (e.g., a user name and password) to the online service 116. In additional or alternative embodiments, establishing the session 202 involves the user application 126 accessing the online service 116 (with or without logging into the online service 116) and the online service 116 providing a cookie to the computing device 124. The cookie, which expires after a certain time period, is used by the online service 116 to associate subsequent transactions with the user application 126 (and the computing device 124) during a time period before the cookie's expiration. The session 202 may be terminated upon expiration of the cookie.

During the session 202, the user application 126 provides device data 204 to the online service 116. The device data 204 includes one or more of authentication data, which may be used to directly match a given user credential to the computing device 124, and probabilistic data (e.g., location data, IP address, browsing history, etc.), which may be information other than user credentials or authentication that may be used to select one or more device clusters that match the computing device 124. The device data 204 also includes an identifier specific to the computing device 124. Examples of this identifier include a media access control (“MAC”) address, an IP address, or any other data that may be used by one or more online services to uniquely identify the computing device 124.

FIG. 2 also depicts the real-time processing module 102 obtaining a set of real-time device cluster data 104, which can include a copy of the batch-processed device cluster data 108 as updated with additional data received in real time. For example, as described above, the data management system 100 may generate the real-time device cluster data 104 by copying at least some of the batch-processed device cluster data 108 outputted by the batch-processing service 112. In the example depicted in FIG. 2, the real-time device cluster data 104 includes data describing a device cluster 206, which includes device data 208 and user data 210. The device cluster 206 indicates that one or more computing devices identified in the device data 208 are associated with a user, household, or other entity identified in the user data 210.

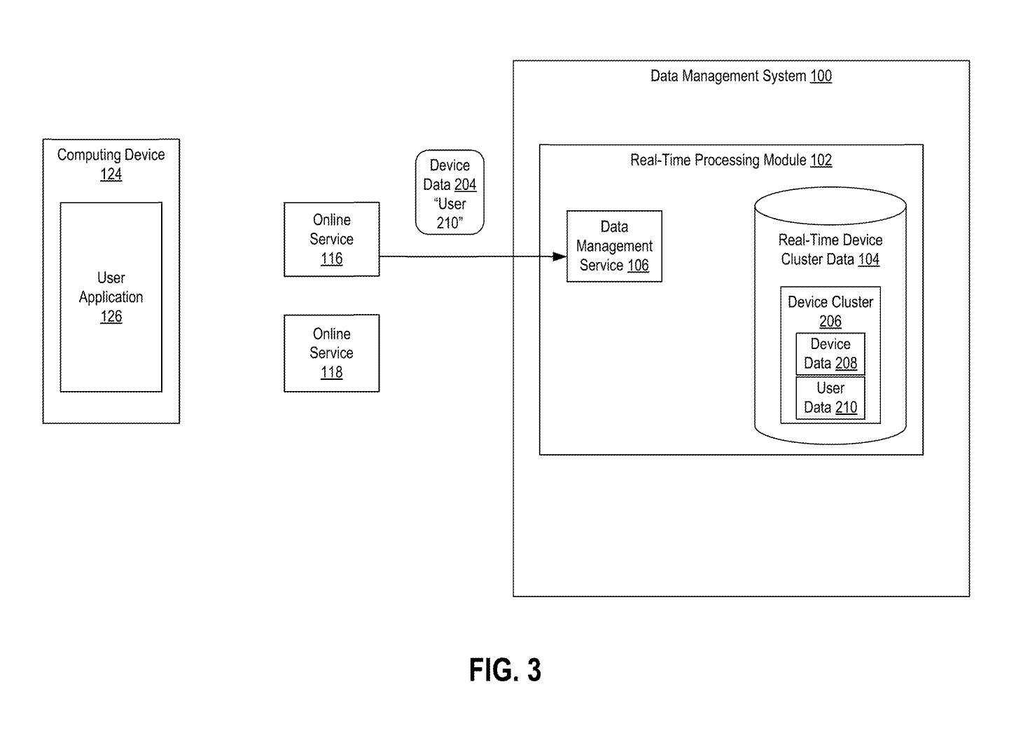

FIG. 3 is a block diagram depicting the online service 116 providing the device data 204 to the data management service 106. As depicted in FIG. 3, the device data 204 includes at least some information matching the user data 210 from the device cluster 206. For example, the device data 204 may indicate that the computing device 124 provided the authentication data “Authenticated_User_1” to the online service 116, and the device cluster 206 may include user data 210 that includes the same credential “Authenticated_User_1” for the online service 116. The device data 208 in the device cluster 206 may lack data about the computing device 124 if, for example, the computing device 124 has not been previously used by any entity described in the user data 210.

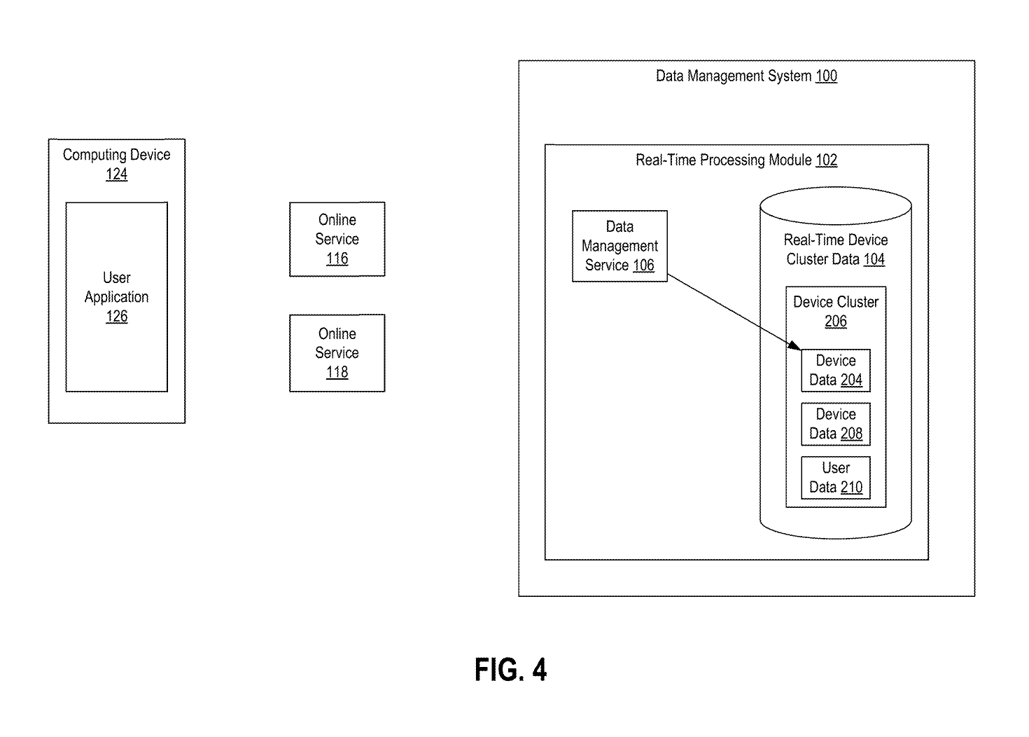

FIG. 4 is a block diagram depicting the data management service 106 updating the real-time device cluster data 104 with the received device data 204. For example, the device data 204 may include the authentication data “Authenticated_User_1” and a MAC address for the computing device 124 from which this authentication data was received. The data management service 106 identifies the cluster 206 based on the user data 210 having the credential “Authenticated_User_1.” The data management service 106 updates the device cluster 206 in the real-time device cluster data 104 so that the device cluster 206 includes at least some of the device data 204 that was received in real time. Therefore, if the updated real-time device cluster data 104 is later used to identify a list of devices associated with “Authenticated_User_1,” the received MAC address for the computing device 124 is included in the list of devices associated with the device cluster 206.

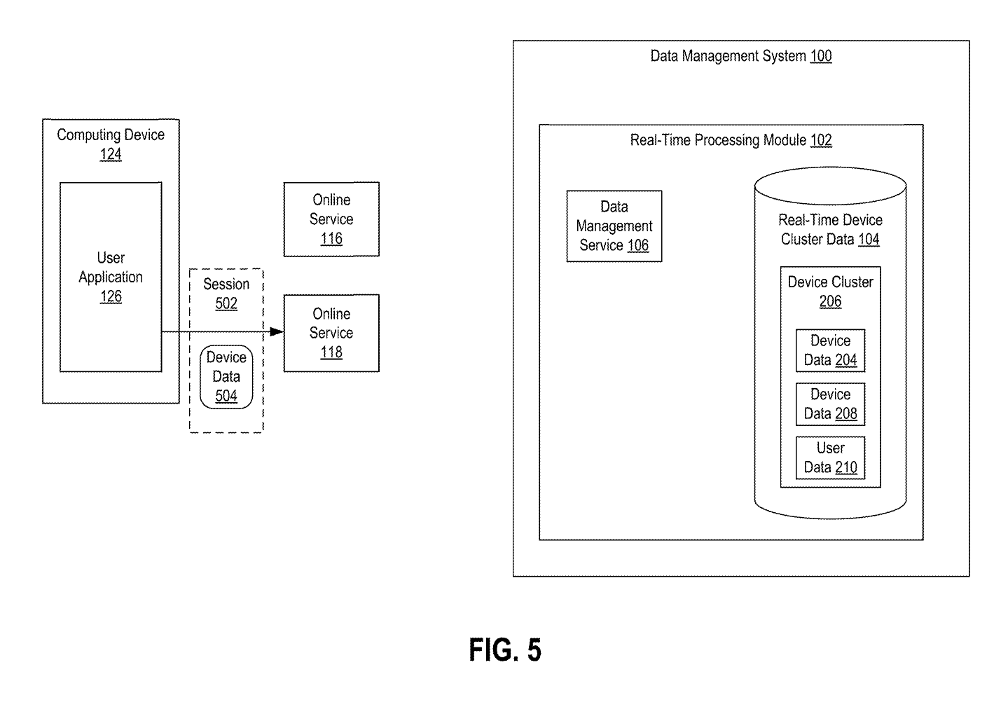

For example, FIG. 5 is a block diagram depicting a different online service 118 being accessed by the computing device 124 subsequent to the device cluster 206 being updated (as depicted in FIG. 4). The computing device 124 establishes a session 502 with the online service 118. The computing device 124 may not identify a user of the computing device during the session 502. For example, the online service 118 may provide a cookie to the computing device 124 in response to the user application 126 (e.g., a web browser) accessing a website provided by the online service 118. The cookie allows the online service 118 to attribute activity to the computing device 124 even if the online service 118 does not receive user information from the computing device 124.

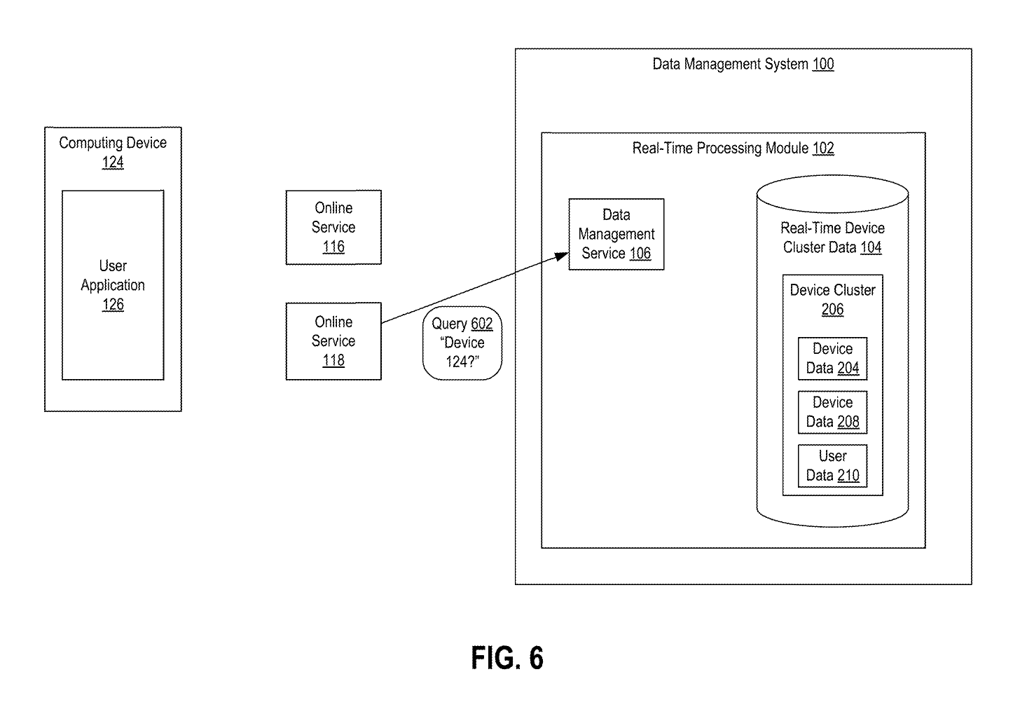

It may be desirable for the online service 118 to customize an online experience (e.g., a web visit) for the computing device 124 if, for example, the computing device 124 is likely being used by a previously encountered user of the online service 118. Therefore, as depicted in FIG. 6, the online service 118 transmits a query 602 to the data management service 106 requesting information about a potential user of the computing device 124. The query 602 may include, for example, a MAC address for the computing device 124, a sequence of web pages accessed by the computing device 124, or any other information that may be used by the data management service 106 to identify one or more device clusters that match the computing device 124.

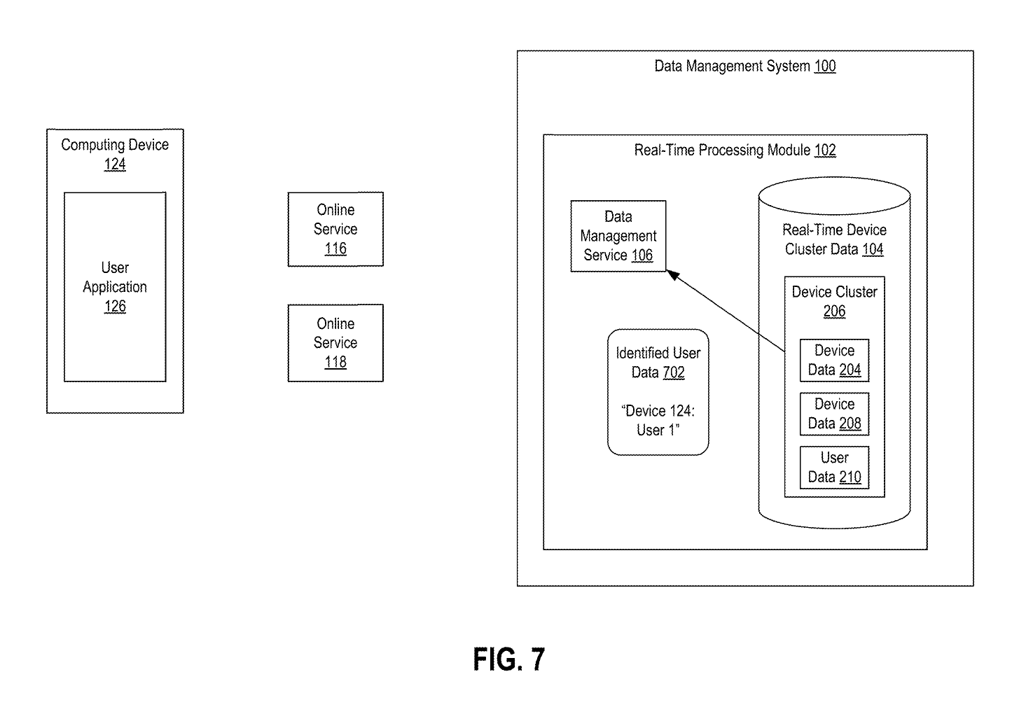

FIG. 7 is a block diagram depicting the data management service 106 using the device cluster 206, as updated in FIG. 4, to identify a user that matches the information in the query 602. For example, if the query 602 from the online service 118 includes a MAC address for the computing device 124, the data management service 106 identifies the cluster 206 using the MAC address from the device data 204 that was received in real time from the online service 116. The data management service 106 uses the identified device cluster 206 to identify a user that is associated with the computing device 124. For example, the user data 210 in the device cluster 206 may include a user name specific to the querying online service 118. The data management service 106 selects the user name as a set of identified user data 702 based on the user name being included in the identified device cluster 206.

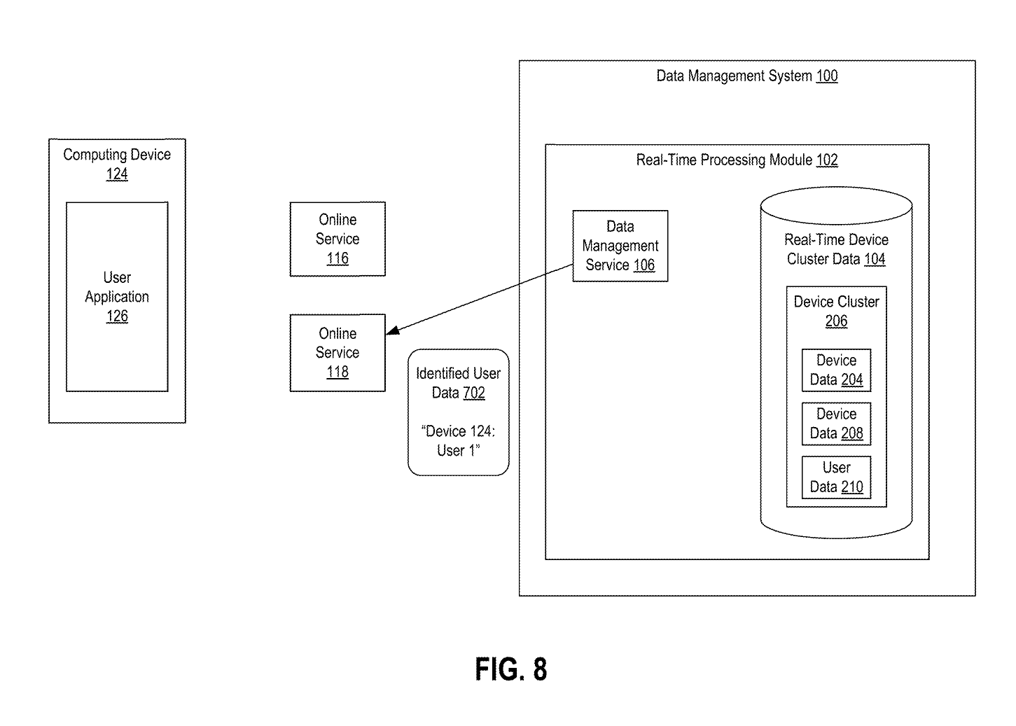

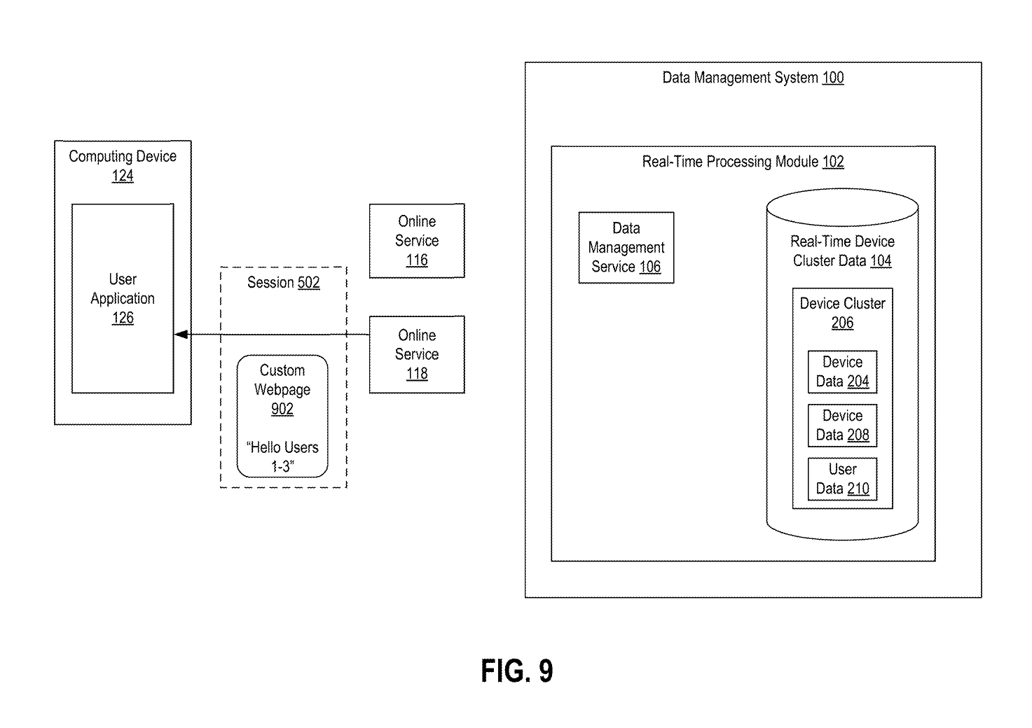

In the example depicted in FIG. 8, the data management service 106 responds to the query from the online service 118 with the identified user data 702. In the example depicted in FIG. 9, the online service 118 customizes an online experience based on the identified user data 702. For example, if the online service 118 has stored information about the preferences of a user in the identified user data 702, the online service 118 generates a custom webpage 902 that reflects those preferences. In this manner, the data management service 106 has used a combination of real-time data received from a first online service 116 and previously batch-processed data to allow a second online service 118 to present a customized online experience.

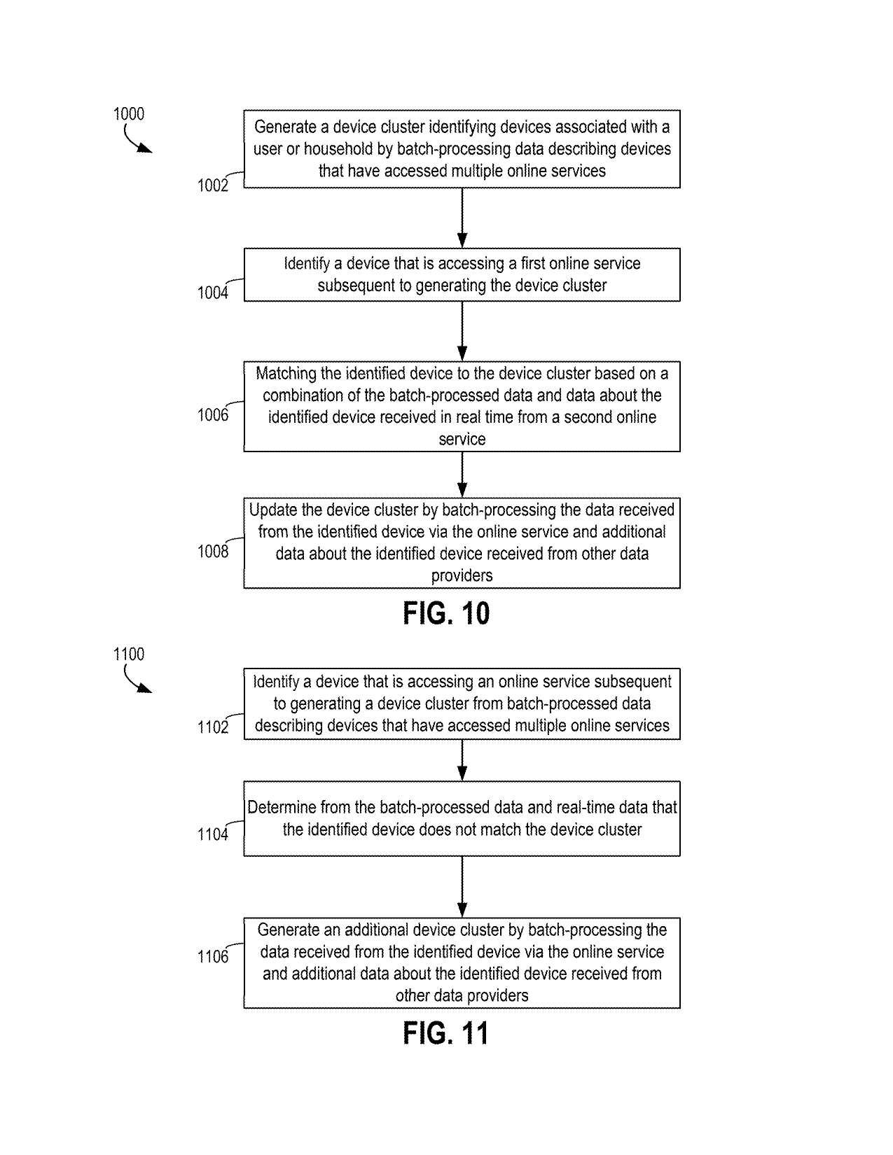

FIG. 10 is a flow chart depicting an example of a process 1000 for matching a device that accesses an online service with a specific user or household using a combination of real-time data and batch processed data about the device received from multiple online services. In some embodiments, one or more processing devices of the data management system 100 implement operations depicted in FIG. 10 by executing suitable program code (e.g., the data management service 106, the batch-processing service 112, etc.). For illustrative purposes, the process 1000 is described with reference to the examples depicted in FIGS. 1-9. Other implementations, however, are possible.

At block 1002, the process 1000 involves generating a device cluster identifying devices associated with a user or household by batch processing data describing devices that have accessed multiple online services. In some embodiments, a processing device generates a device cluster 206 that includes device data 208 and user data 210. The device data 208 identifies one or more devices. The user data 210 identifies a user, household, or other entity that is associated with the devices identified by the device data 208.

In some embodiments, the processing device generates the device cluster 206 by executing the batch-processing service 112 and thereby batch processing at least some of the device data 114. The device data 114 is received from device data providers 122. The device data 114 includes data received from a device accessing one or more online services using the data management service 106, data that is received from third parties (e.g., other online services that may not use the data management service 106) and that describes devices that have accessed other online services, or some combination thereof.

At block 1004, the process 1000 involves identifying a device that is accessing a first online service subsequent to generating the device cluster. In the example described above with respect to FIGS. 5 and 6, a processing device receives a query 602 from an online service 118. The query 602 includes data describing one or more attributes associated with a computing device 124 (e.g., a MAC address assigned to a network interface of the computing device 124) that accesses the online service 118 during a session 502. The processing device determines from the data in the query 602 that the online service 118 is being accessed by the computing device 124.

At block 1006, the process 1000 involves matching the identified device to the device cluster based on a combination of the batch-processed data and data about the identified device that is received in real-time from a second online service. In some embodiments, a processing device, which executes the data management service 106, uses the real-time device cluster data 104 to match the computing device 124 to a potential user, household, or other entity.

In the example described above with respect to FIG. 7, the real-time device cluster data 104 includes both the batch-processed data (e.g., device data 208, user data 210) generated at block 1002 and the device data 204 that was received during a real-time session 202 between another online service 116 and the computing device 124. The data management service 106 accesses the device data 204 that was received in real time from the online service 116. The data management service 106 matches the device data 204 with device information received in the query 602 from the online service 118. In this manner, the data management service 106 matches the computing device 124 to the real-time device cluster 206 and its user data 210. In the example described above with respect to FIGS. 8 and 9, the data management service 106 responds to the query 602 by transmitting the identified user data 702 to the querying online service 118, which can use the identified user data 702 to deliver a custom webpage 902.

At block 1008, the process 1000 involves updating the device cluster by batch-processing the data received from the identified device via the online service and additional data about the identified device received from other data providers. In some embodiments, block 1004 involves updating the device data 114 with additional data generated after the batch-processed device cluster data 108 was generated or updated.

In the example described above, the data management system 100 updates the device data 114 with the real-time device cluster data 104, which has been updated with real-time data received by the data management service 106 from the online services 116, 118, 120. For instance, the real-time device cluster data 104 may include the device data 204, which describes one or more attributes associated with the computing device 124 and its session 202 with the online service 116. Additionally or alternatively, the data management system 100 updates the device data 114 with data received from other online services or other device data providers 122 that describes computing devices that have accessed online services since the most recent update of the batch-processed device cluster data 108.

The updated device data 114 is used to update existing device clusters, generate new device clusters, or both. In one example, the batch-processing service 112 executes a batch processing algorithm that verifies the association between the computing device 124 and a user identified in identified user data 702. The device cluster 206 is therefore updated in the batch-processed device cluster data 108. The updated device cluster data 108, which indicates the verified association between the computing device 124 and a user in device cluster 206, becomes available for subsequent operations by the real-time processing module 102.

The process 1000 depicted in FIG. 10 is provided for illustrative purposes only. Other implementations are possible. For example, one or more operations depicted in FIG. 10, such as the operation in block 1008, may be omitted without departing from the scope of this disclosure.

In additional or alternative embodiments, device data received in real-time is used to generate new device clusters. For example, FIG. 11 is a flow chart depicting an example of a process 1100 for generating a new device cluster based on a failure to match a device with a specific user or household. In some embodiments, one or more processing devices of the data management system 100 implement operations depicted in FIG. 11 by executing suitable program code (e.g., the data management service 106, the batch-processing service 112, etc.). For illustrative purposes, the process 1100 is described with reference to the examples depicted in FIGS. 1-10. Other implementations, however, are possible.

At block 1102, the process 1100 involves identifying a device that is accessing an online service subsequent to generating a device cluster from batch-processed data about devices that have accessed multiple online services. In one example, the data management system 100 receives device data from one or more of the online services 116, 118, 120. The device data describes one or more attributes associated with a computing device 128. The processing device determines from the device data that the computing device 124 has established a session with, or is otherwise accessing, one or more of the online services 116, 118, 120.

At block 1104, the process 1100 involves determining, from the batch-processed data and real-time data, that the identified device does not match the device cluster that was generated via a prior batch-processing operation. For example, the data management service 106 may compare device data describing one or more attributes of a device 128 with one or more device clusters included in the real-time device cluster data 104. The real-time device cluster data 104 includes device clusters from the batch-processed device cluster data 108, some of which may have been updated using real-time data that was received by the data management system 100 after the most recent update to the batch-processed device cluster data 108.

The attributes of the computing device 128 may not correspond to attributes from at least some of the device clusters in the real-time device cluster data 104. For example, a hardware identifier of the computing device 128 may not have been previously encountered by any of the online service 116, 118, 120 if the computing device 128 is brand new. The data management service 106 therefore determines that the computing device 128 does not match at least some of the device clusters.

At block 1106, the process 1100 involves generating an additional device cluster by batch-processing the data received from the identified device via the online service and additional data about the identified device received from other data providers. Block 1106 may be implemented using device data 114 that has been updated in a manner similar to the description of block 1008 provided above. The updated device data 114 can include the real-time data about the newly encountered computing device 128 and, for example, data received from other online services or other device data providers 122 about the computing device 128. The batch-processing service 112 generates a new device cluster that is associated with the computing device 128. The batch-processing service 112 outputs updated batch-processed device cluster data 108 that includes the new device cluster. The updated device cluster data 108 becomes available for subsequent operations by the real-time processing module 102.

In additional or alternative embodiments, a conflict may arise between a device-to-user match indicated by the batch-processed device cluster data 108 and a device-to-user match indicated by real-time data received from online services after a batch-processing algorithm. For example, a given device may be matched to a first user through the batch-processed data and matched to a second user through the real-time data.

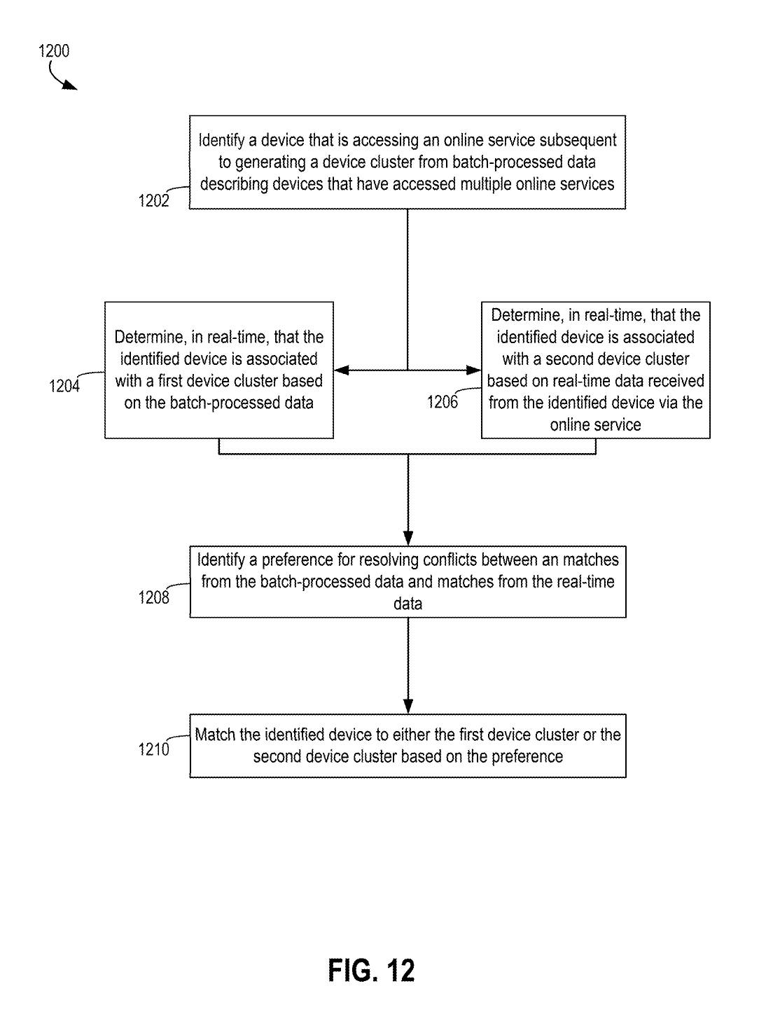

FIG. 12 is a flow chart depicting an example of a process 1200 for resolving conflicts between real-time device data and batch-processed device data in matching a device to a user or household. In some embodiments, one or more processing devices of the data management system 100 implement operations depicted in FIG. 12 by executing suitable program code (e.g., the data management service 106, the batch-processing service 112, etc.). For illustrative purposes, the process 1200 is described with reference to the examples depicted in FIGS. 1-11. Other implementations, however, are possible.

At block 1202, the process 1200 involves identifying a device that is accessing an online service subsequent to generating a device cluster from batch-processed data about devices that have accessed multiple online services. Block 1202 may be implemented using device data 114 that has been updated in a manner similar to the description of block 1102 provided above.

At block 1204, the process 1200 involves determining, in real-time and based on the batch-processed data, that the identified device is associated with a first device cluster. For example, the data management service 106 may compare device data describing one or more attributes of a device 128 with one or more device clusters included in the real-time device cluster data 104. The real-time device cluster data 104 includes device clusters from the batch-processed device cluster data 108. The data management service 106 determines that the device data describing one or more attributes of a device 128 matches or otherwise corresponds to one or more attributes of a device cluster that was generated or updated during a previous batch-processing operation. The identified device cluster may not have been updated with real-time information about the device 128 since the previous batch-processing operation. The comparison may indicate that the identified device 128 is associated with a first user or household.

At block 1206, the process 1200 involves determining, based on real-time data received since the previous batch-processing operation, that the identified device is associated with a second device cluster that is different from the first device cluster identified in block 1204. In some embodiments, the data management service 106 compares device data describing one or more attributes of a device 128 with device data received from one or more of the online services 116, 118, 120 since the previous batch-processing operation.

The comparison may indicate that the identified device 128 is associated with a second user or household that has not been previously associated with the first user or household. For example, the first and second users or household may have significant disparities in their respective characteristics. Examples of these significant disparities include a male first user and a second female user, a first user in the 20-30 age demographic and a second user in the 60-70 age demographic, a first household located in one country and a second household located in another country, etc. The data management service 106 may determine, based on these significant differences between the first and second clusters, that the identified device 128 should be matched to one cluster or the other, but not both.

At block 1208, the process 1200 involves identifying a preference for resolving conflicts between matches from the batch-processed data and matches from the real-time data. For example, the data management service 106 may access data in a non-transitory computer-readable medium that describes the preference. In some embodiments, the preference may be a user-selected option, such as a preference that results from the batch-processed data are preferred over results from the real-time data, or vice versa.

In additional or alternative embodiments, the data management system 100 uses differently weighted attributes that associated with computing devices to identify a cluster to which a certain computing device should be assigned. For example, in a batch-processing operation, the data management system 100 can use device attributes with a first weight to assign a device to a first cluster. Subsequent to the batch-processing operation, the data management system 100 can receive real-time data about device attributes with a second weight. The real-time data can indicate that assignment to a second cluster is more appropriate. If the second weight for the real-time data is greater than the first weight for the batch-processed data, the data management system 100 can reassign the device from the first cluster to the second cluster. For example, the data management system 100 can weigh authentication information more heavily than an IP address and can weigh authentication information for a bank account more heavily than authentication information for a social media account.

In additional or alternative embodiments, the preference use one or more confidence scores associated with device clusters generated by the batch-processing service 112. For example, in addition to generating or updating a cluster, the batch-processing service 112 may identify a confidence score for each association between a device and the cluster, each association between a user and the cluster, or both. A higher confidence score indicates a greater reliability in the user-to-device association indicated by the cluster. For example, if device data for a certain device indicates that the same user credential “User_1” was used for 95% of the authentication events involving the device, the batch-processing service 112 may provide a high confidence score for the association between the device and the user with the credential “User_1.” By contrast, if device data for a device indicates that the same user credential “User_1” was used for 5% of the authentication events involving the device, the batch-processing service 112 may provide a low confidence score for the association between the device and the user with the credential “User_1.” In block 1208, the data management service 106 may determine whether a confidence score should be used to resolve a conflict between batch-processed data and real-time data, where a confidence score above a threshold results in the selection of the batch-processed data and a confidence score below the threshold results in the selection of the real-time data when assigning a device to a cluster.

At block 1210, the process 1200 involves matching the identified device to either the first device cluster or the second device cluster based on the preference. In one example, the data management service 106 may determine from the preference that results from the batch-processed data are preferred over results from the real-time data. Therefore, the data management service 106 matches the identified device 128 to the first device cluster. In another example, the data management service 106 may determine from the preference that results from the real-time data are preferred over results from the batch-processed. Therefore, the data management service 106 matches the identified device 128 to the second device cluster.

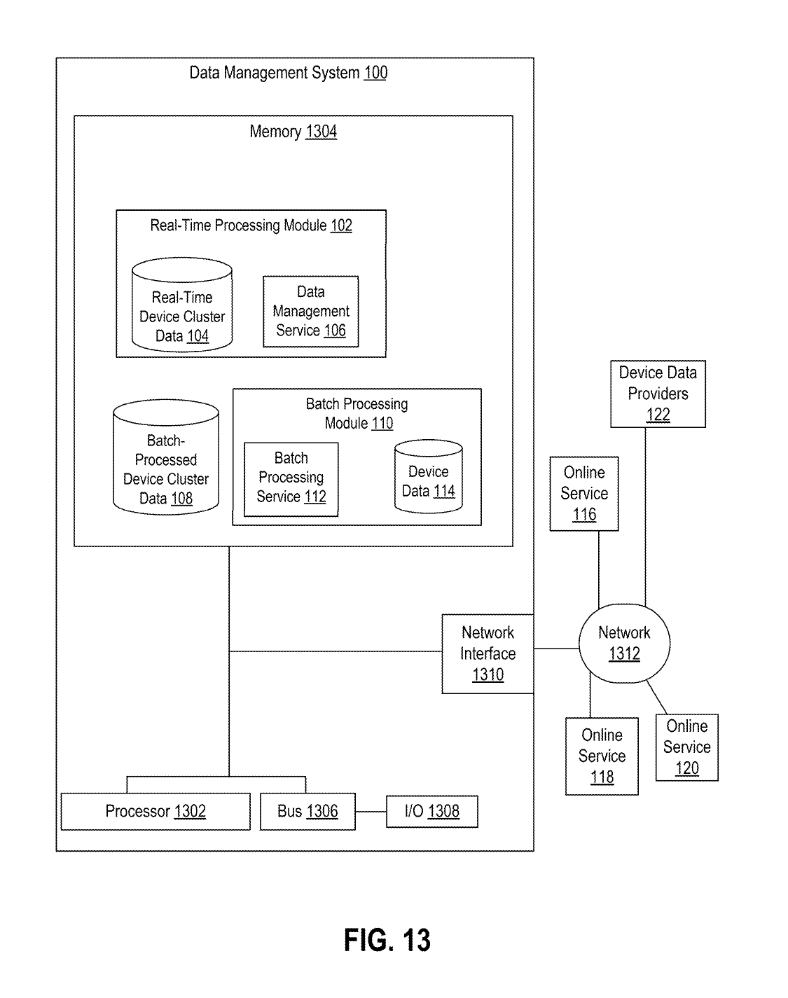

Any suitable computing system or group of computing systems can be used for performing the operations described herein. For example, FIG. 13 is a block diagram depicting an example of a data management system 100 that matches computing devices with users, households, or other entities using real-time data and batch-processed data.

The depicted example of the data management system 100 includes one or more processors 1302 communicatively coupled to one or more memory devices 1304. The processor 1302 executes computer-executable program code and/or accesses information stored in the memory device 1304. Examples of processor 1302 include a microprocessor, an application-specific integrated circuit (“ASIC”), a field-programmable gate array (“FPGA”), or other suitable processing device. The processor 1302 can include any number of processing devices, including one.

The memory device 1304 includes any suitable non-transitory computer-readable medium for storing the real-time processing module 102, the batch-processing module 110, and the batch-processed device cluster data 108. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The data management system 100 may also include a number of external or internal devices such as input or output devices. For example, the data management system 100 is shown with an input/output (“I/O”) interface 1308 that can receive input from input devices or provide output to output devices. A bus 1306 can also be included in the data management system 100. The bus 1306 can communicatively couple one or more components of the data management system 100.

The data management system 100 executes program code that configures the processor 1302 to perform one or more of the operations described above with respect to FIGS. 1-12. The program code includes, for example, one or more of the data management service 106, the batch-processing service 112, or other suitable applications that perform one or more operations described herein. The program code may be resident in the memory device 1304 or any suitable computer-readable medium and may be executed by the processor 1302 or any other suitable processor. In some embodiments, the program code described above, the real-time device cluster data 104, the batch-processed device cluster data 108, and the device data 114 are stored in the memory device 1304, as depicted in FIG. 13. In additional or alternative embodiments, one or more of the real-time device cluster data 104, the batch-processed device cluster data 108, the device data 114, and the program code described above are stored in one or more memory devices accessible via a data network, such as a memory device accessible via a cloud service.

The data management system 100 depicted in FIG. 13 also includes at least one network interface 1310. The network interface 1310 includes any device or group of devices suitable for establishing a wired or wireless data connection to one or more data networks 1312. Non-limiting examples of the network interface 1310 include an Ethernet network adapter, a modem, and/or the like. The data management system 100 is able to communicate with one or more online services 116, 118, 120 and one or more device data providers 122 using the network interface 1310.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method for matching devices that access online services with users or households using a combination of real-time data and batch-processed data about the devices received from multiple online services, the method comprising:
generating, by a processor, a device cluster that identifies devices associated with a user or household, wherein the device cluster is generated by batch-processing data received from devices accessing the online services and data received from third parties that describes devices that have accessed other online services;
identifying, by the processor, a device that is accessing a first online service subsequent to generating the device cluster; and
matching, by the processor, the identified device to the device cluster based on a combination of the batch-processed data and data about the identified device received in real-time from a second online service, wherein the identified device is matched to the device cluster while the identified device is accessing the online service.

2. The method of claim 1, wherein the method further comprises, prior to matching the identified device:
receiving device data from the second online service include a device identifier for the identified device and an attribute of a user accessing the second online service,
determining that the received attribute is sufficiently similar to an attribute of the device cluster, and
updating the device cluster to include the received device identifier;
wherein matching the identified device to the device cluster comprises:
receiving a query from the first online service, wherein the query references the device identifier,
determining that the updated device cluster includes the device identifier, and
transmitting user data associated with the device cluster to the first online service.

3. The method of claim 1, wherein the method further comprises updating the device cluster by batch-processing the data received from the identified device via the online service and additional data about the identified device received from at least some of the third parties.

4. The method of claim 1, wherein the method further comprises:
identifying, by the processor subsequent to generating the device cluster, an additional device that is accessing the online service;
determining, by the processor, that the additional device does not match the device cluster based on a combination of the batch-processed data and data received from the additional device via the online service; and
generating, by the processor, an additional device cluster associated with the additional device.

5. The method of claim 4, wherein the method further comprises updating the additional device cluster by batch-processing the data about the additional device received from the identified device via the online service and additional data about the additional device received from at least some of the third parties.

6. The method of claim 1, wherein the batch-processed data includes authentication data for accessing the online services and probabilistic data other than authentication data for accessing the online services, wherein the probabilistic data is indicative of associations between devices and users or households.

7. The method of claim 6, wherein the probabilistic data comprises at least one of:
web browsing histories from the devices;
search histories from the devices;
IP addresses of the devices identified by the cluster; and
geographic location data describing at least one of a device in the cluster and the user or household.

8. The method of claim 1, wherein the method further comprises:
identifying, by the processor, an additional device that is accessing the online service subsequent to generating the device cluster;
while the additional device is accessing the online service:
determining, by the processor, that the batch-processed data indicates that the additional device is associated with the device cluster,
determining, by the processor, that data received from the additional device via the online service indicates that the additional device is associated with an additional device cluster,
identifying a preference for resolving conflicts between an association determined from the batch-processed data and an association determined from data received while devices access the online service,
matching the additional device to either the device cluster or the additional device cluster based on the preference.

9. A system for matching devices that access online services with users or households using a combination of real-time data and batch-processed data about the devices received from multiple online services, the system comprising:
a processor;
a non-transitory computer-readable medium communicatively coupled to the processor,
wherein the processor is configured for executing program code stored in the non-transitory computer-readable medium and thereby performing operations comprising:
generating a device cluster that identifies devices associated with a user or household, wherein the device cluster is generated by batch-processing data received from devices accessing the online services and data received from third parties that describes devices that have accessed other online services,
identifying a device that is accessing a first online service subsequent to generating the device cluster, and
matching the identified device to the device cluster based on a combination of the batch-processed data and data about the identified device received in real-time from a second online service, wherein the identified device is matched to the device cluster while the identified device is accessing the online service.

10. The system of claim 9, wherein the processor is further configured for performing operations comprising, prior to matching the identified device:
receiving device data from the second online service include a device identifier for the identified device and an attribute of a user accessing the second online service,
determining that the received attribute is sufficiently similar to an attribute of the device cluster, and
updating the device cluster to include the received device identifier;
wherein the processor is configured for matching the identified device to the device cluster by:
receiving a query from the first online service, wherein the query references the device identifier,
determining that the updated device cluster includes the device identifier, and
transmitting user data associated with the device cluster to the first online service.

11. The system of claim 9, wherein the processor is further configured for performing operations comprising updating the device cluster by batch-processing the data received from the identified device via the online service and additional data about the identified device received from at least some of the third parties.

12. The system of claim 9, wherein the processor is further configured for performing operations comprising:
identifying, subsequent to generating the device cluster, an additional device that is accessing the online service;
determining that the additional device does not match the device cluster based on a combination of the batch-processed data and data received from the additional device via the online service; and
generating an additional device cluster associated with the additional device.

13. The system of claim 12, wherein the processor is further configured for performing operations comprising updating the additional device cluster by batch-processing the data about the additional device received from the identified device via the online service and additional data about the additional device received from at least some of the third parties.

14. The system of claim 9, wherein the batch-processed data includes authentication data for accessing the online services and probabilistic data other than authentication data for accessing the online services, wherein the probabilistic data is indicative of associations between devices and users or households.

15. The system of claim 14, wherein the probabilistic data comprises at least one of:
web browsing histories from the devices;
search histories from the devices;
IP addresses of the devices identified by the cluster; and
geographic location data describing at least one of a device in the cluster and the user or household.

16. The system of claim 9, wherein the processor is further configured for performing operations comprising:
identifying an additional device that is accessing the online service subsequent to generating the device cluster;
while the additional device is accessing the online service:
determining that the batch-processed data indicates that the additional device is associated with the device cluster,
determining that data received from the additional device via the online service indicates that the additional device is associated with an additional device cluster,
identifying a preference for resolving conflicts between an association determined from the batch-processed data and an association determined from data received while devices access the online service,
matching the additional device to either the device cluster or the additional device cluster based on the preference.

17. A non-transitory computer-readable medium having program code stored thereon that is executable by a processor for matching devices that access online services with users or households using a combination of real-time data and batch-processed data about the devices received from multiple online services, the program code comprising:
generating, by a processor, a device cluster that identifies devices associated with a user or household, wherein the device cluster is generated by batch-processing data received from devices accessing the online services and data received from third parties that describes devices that have accessed other online services;
identifying, by the processor, a device that is accessing a first online service subsequent to generating the device cluster; and
matching, by the processor, the identified device to the device cluster based on a combination of the batch-processed data and data about the identified device received in real-time from a second online service, wherein the identified device is matched to the device cluster while the identified device is accessing the online service.

18. The non-transitory computer-readable medium of claim 17, wherein the non-transitory computer-readable medium further comprises program code for performing operation comprising, prior to matching the identified device:
receiving device data from the second online service include a device identifier for the identified device and an attribute of a user accessing the second online service,
determining that the received attribute is sufficiently similar to an attribute of the device cluster, and
updating the device cluster to include the received device identifier;
wherein matching the identified device to the device cluster comprises:
receiving a query from the first online service, wherein the query references the device identifier,
determining that the updated device cluster includes the device identifier, and
transmitting user data associated with the device cluster to the first online service.

19. The non-transitory computer-readable medium of claim 17, wherein the non-transitory computer-readable medium further comprises program code for updating the device cluster by batch-processing the data received from the identified device via the online service and additional data about the identified device received from at least some of the third parties.

20. The non-transitory computer-readable medium of claim 17, wherein the non-transitory computer-readable medium further comprises:
program code for identifying, subsequent to generating the device cluster, an additional device that is accessing the online service;
program code for determining that the additional device does not match the device cluster based on a combination of the batch-processed data and data received from the additional device via the online service; and
program code for generating an additional device cluster associated with the additional device.
